(19) United States
(12) Patent Application Publication
(10) Pub. No.: US 2006/0261757 A1
(43) Pub. Date: Nov. 23, 2006

(54) POWER-SUPPLIER DUPLEXING OPERATION APPARATUS AND OPERATION METHOD THEREOF

(76) Inventor: Shih-Chung Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/461,779

(22) Filed: Aug. 2, 2006

Related U.S. Application Data
(63) Continuation-in-part of application No. 10/904,546, filed on Nov. 16, 2004, now Pat. No. 7,106,009.

(30) Foreign Application Priority Data
May 4, 2004 (TW) 93112472

(51) Int. Cl. H05B 37/02

(52) U.S. Cl. 315/308

(57) ABSTRACT

A power-supplier duplexing operation apparatus and operation method thereof are provided. The apparatus comprises a first power supplier for driving a first load and a second power supplier for driving a second load, wherein the first power supplier includes a first converter and a first control circuit. The first converter converts an input power to a first output power for driving the first load in accordance with the control signal output from a first control circuit. Moreover, the second converter converts the input power to a second output power for driving the second load in accordance with a first detection signal output from a first detection module contained in the first power supplier.

### CROSS-REFERENCE TO RELATED APPLICATION

This application is a continuation-in-part of a prior application Ser. No. 10/904,546, filed Nov. 16, 2004, which claims the priority benefit of Taiwan application serial no. 93112472, filed on May 4, 2004. All disclosures are incorporated herewith by reference.

### BACKGROUND OF THE INVENTION

1. Field of the Invention

The present invention relates to power suppliers for driving lighting devices and an operation method thereof, and more particularly to a power-supplier duplexing operation apparatus and an operation method thereof.

2. Description of Related Art

Fluorescent Lamp (FL) has been applied to the backlight system of LCD because of its advantages of better emission efficiency and longer life time compared to traditional lamp. In addition to the Fluorescent Lamp, light-emitting diodes (LEDs) also can be an alternative as a lighting device for backlight system of LCD. With advancement of the LCD technology, it is possible to manufacture LCD with larger screen size than before. By this trend, a multiple-lamp system applied to LCD has also become more sophisticated.

In a multiple-lighting-device system, usually multiple power suppliers (each of which including its respective controller) for driving the lighting devices are used. Due to the structure of the multiple power suppliers, the communication between these power suppliers is more complicated than that of a single power supplier. The improvement of communication between the power suppliers provides a plurality of advantages, in addition to providing the lighting devices with duplexing protection system for safety concern. The plurality of advantages comprise coordinating operation signals for driving the lighting devices, such as, dimming signal for achieving an optimal brightness and a predetermined phase shift between two lighting devices' lighting frequencies for reducing flicker caused by a dimming effect.

Additionally, applicant's previously filed U.S. application Ser. No. 10/904,546 discloses a duplexing protection apparatus only for Fluorescent Lamp, not for the LEDs, which thereby requires another duplexing operation apparatus. Furthermore, communication between the power suppliers may be, in addition to a two-way communication, a one-way communication, which is one modified manner of duplexing operation for the power suppliers and can be regarded as an issued “command” signal from one of the power suppliers. For example, once a malfunction occurs to one of the power suppliers, it is able to adjust itself operation in accordance with the “command” signal issued from another power supplier so as to improve electrical performance of the multiple-lighting-device system, such as uniform brightness or less power-consumption.

To achieve the aforementioned advantages, there exists a need for devising a power-supplier duplexing operation apparatus and operation method thereof.

### SUMMARY OF THE INVENTION

Accordingly, the present invention is directed to a power-supplier duplexing operation apparatus and operation method thereof. The apparatus includes two power suppliers, wherein, once a malfunction occurs to one of the two power supplier, it is able to adjust itself operation in accordance with a duplexing signal issued from another power supplier so as to improve electrical performance of a multiple-lighting-device system. Moreover, the apparatus is able to coordinate operations of the two power suppliers, such as, dimming signals for achieving an optimal brightness.

According to a preferred embodiment of the present invention, a power-supplier duplexing operation apparatus, comprising: a first power supplier for driving a first load, comprising a first control circuit, a first converter and a first detection module, wherein the first converter is coupled to an input power and converts the input power to a first output power for driving the first load in accordance with a control signal output from the first control circuit, as well as the first detection module outputs a first detection signal according to an operation status of the first load; and a second power supplier for driving a second load, comprising a second converter, wherein the second converter is coupled to the input power and converts the input power to a second output power for driving the second load in accordance with the first detection signal.

According to a further preferred embodiment of the present invention, a power-supplier duplexing operation apparatus, comprising: a first power supplier for driving a first load, comprising a first control circuit and a first converter, wherein the first converter is coupled to an input power and converts the input power to a first output power for driving the first load in accordance with a control signal output from the first control circuit, as well as the first control circuit outputs a first duplexing signal; and a second power supplier for driving a second load, comprising a second control circuit and a second converter, wherein the second converter is coupled to the input power and converts the input power to a second output power for driving the second load in accordance with the first duplexing signal.

The present invention is also directed to a method of operating a power-supplier duplexing operation apparatus. The method is implemented to control an operation of a power-supplier duplexing operation apparatus comprising a first power supplier and a second power supplier capable of respectively supplying a power to loads. The method comprises the steps of providing a first power-supplying signal which generated by the first power supplier for indicating a power-supplying status of the first power supplier; and determining a power-supplying status by the second power supplier of the second power supplier according to the first power-supplying signal.

In order to make the aforementioned and other objects, features and advantages of the present invention understandable, a preferred embodiment accompanied with figures is described in detail below.

### BRIEF DESCRIPTION OF THE DRAWINGS

FIG. 1A shows a circuit block diagram represents a two-lamp duplexing protection apparatus according to a modification of a first embodiment of the present invention.

FIG. 1B is an operation flowchart of a two-lamp duplexing protection apparatus according to a modification of a first embodiment of the present invention.

FIG. 2A is a circuit block diagram of a three-lamp duplexing protection apparatus according to a modification of a first embodiment of the present invention.

FIG. 2B is an operational flowchart of a three-lamp duplexing protection apparatus according to a modification of a first embodiment of the present invention.

FIG. 3A is a time chart of a two-lamp duplexing protection apparatus according to a modification of a first embodiment of the present invention.

FIG. 3B is a time chart of a three-lamp duplexing protection apparatus according to a modification of a first embodiment of the present invention.

FIG. 4 is a detail circuit drawing of a two-lamp duplexing protection apparatus according to a modification of a first embodiment of the present invention.

FIG. 5A shows a circuit block diagram represents a two-power-supplier duplexing operation apparatus according to a first embodiment of the present invention.

FIG. 5B shows a circuit block diagram represents another modified two-power-supplier duplexing operation apparatus according to a first embodiment of the present invention.

FIG. 5C shows a circuit block diagram represents a three-power-supplier duplexing operation apparatus according to a first embodiment of the present invention.

FIG. 5D shows a circuit block diagram represents another modified three-power-supplier duplexing operation apparatus according to a first embodiment of the present invention.

FIG. 6A shows a circuit block diagram represents a two-power-supplier duplexing operation apparatus according to a second embodiment of the present invention.

FIG. 6B shows a circuit block diagram represents another modified two-power-supplier duplexing operation apparatus according to a second embodiment of the present invention.

FIG. 6C shows a circuit block diagram represents a three-power-supplier duplexing operation apparatus according to a second embodiment of the present invention.

FIG. 6D shows a circuit block diagram represents another modified three-power-supplier duplexing operation apparatus according to a second embodiment of the present invention.

FIG. 7A shows a circuit block diagram represents a two-power-supplier duplexing operation apparatus according to a third embodiment of the present invention.

FIG. 7B shows a circuit block diagram represents another modified two-power-supplier duplexing operation apparatus according to a third embodiment of the present invention.

FIG. 7C shows a circuit block diagram represents a three-power-supplier duplexing operation apparatus according to a third embodiment of the present invention.

FIG. 7D shows a circuit block diagram represents another modified three-power-supplier duplexing operation apparatus according to a third embodiment of the present invention.

FIG. 8A shows an application of a two-power-supplier duplexing operation apparatus according to a second embodiment of the present invention.

FIG. 8B shows timing charts for a first set LED lighting and a second set LED lighting as shown in FIG. 8A.

FIG. 9 shows an application of a two-power-supplier duplexing operation apparatus according to a third embodiment of the present invention.

FIG. 10 shows a block diagram of ballast according to a second embodiment of the present invention.

### DESCRIPTION OF EMBODIMENTS

Reference will now be made in detail to a structure for assembling a flat display for use in a notebook computer, examples of which are illustrated in the accompanying drawings. Wherever possible, the same reference numbers are used in the drawings and the descriptions to refer to the same parts.

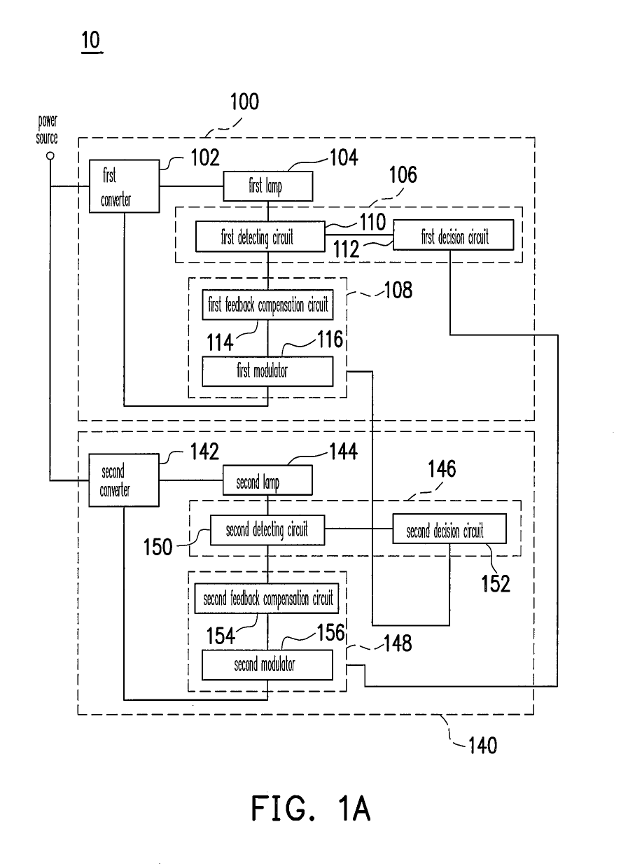

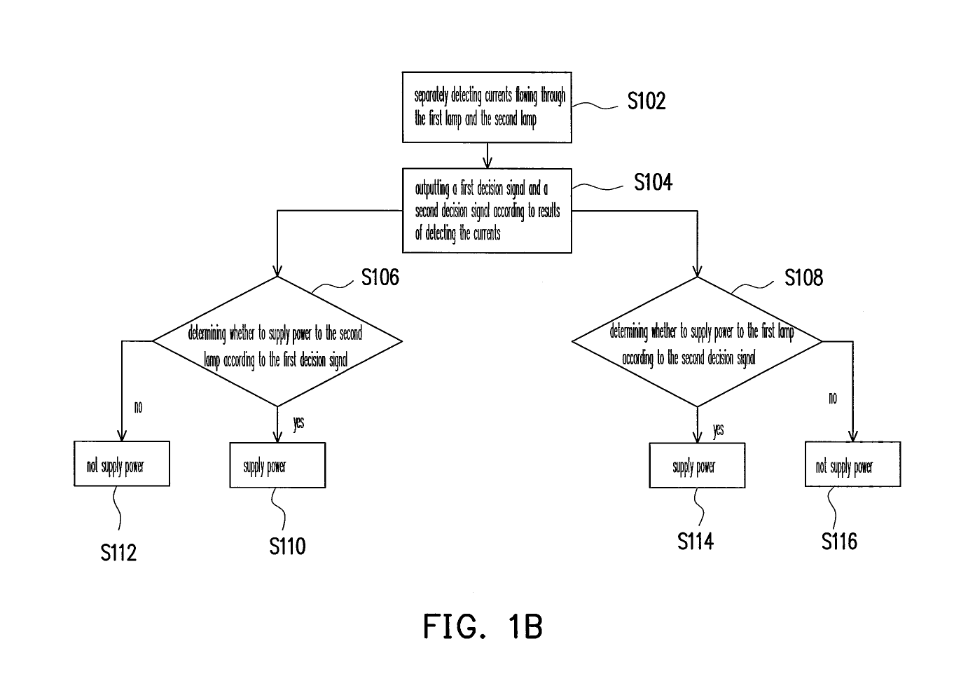

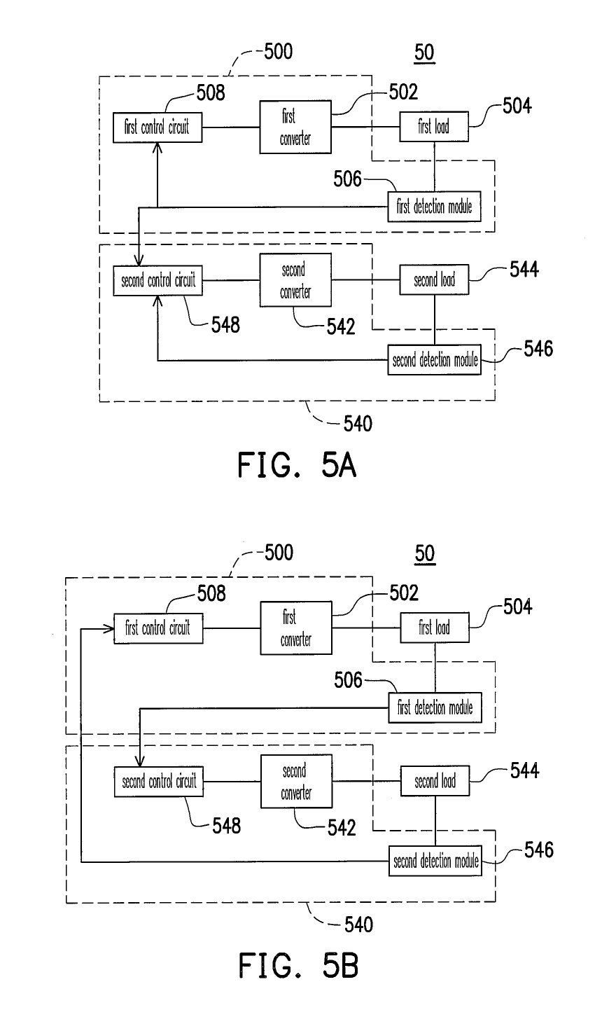

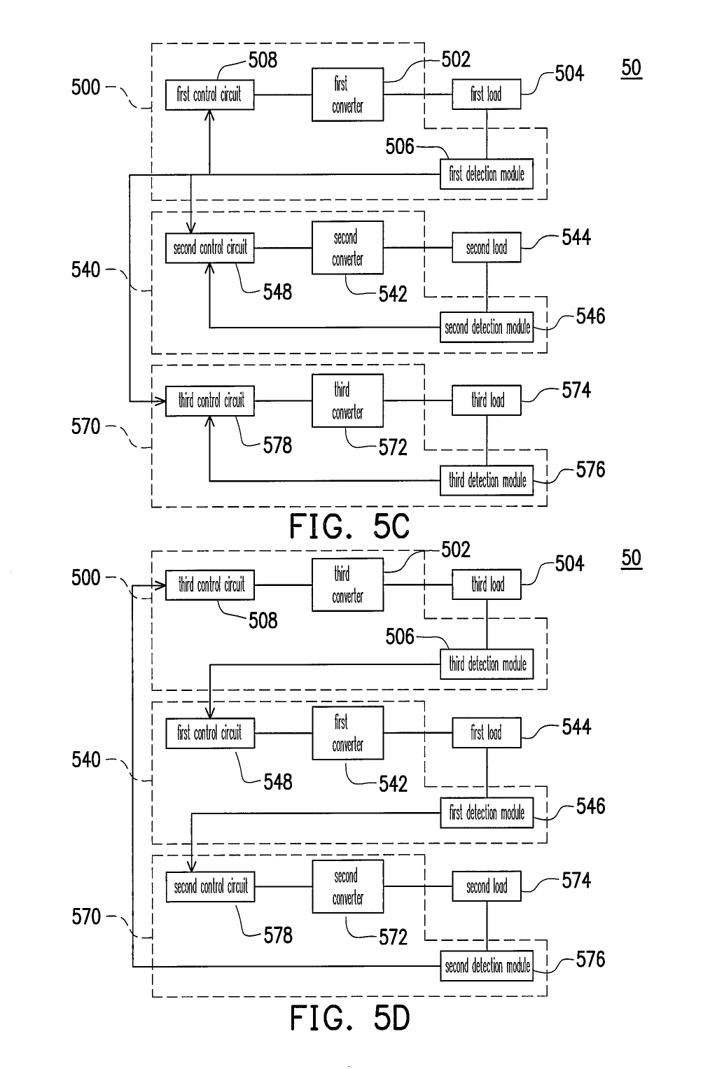

As FIGS. 1-4 are narrow modifications of those in FIG. 5A-5D, FIG. 5A-5D are described in detail prior to the descriptions of FIGS. 1-4. Accordingly, first, referring to FIG. 5A, it shows a circuit block diagram representing a two-power-supplier duplexing operation apparatus according to a first embodiment of the present invention. The two-power-supplier duplexing operation apparatus 50, for driving a first load, comprises a first power-supplier module 500 and a second supplier module 540. Moreover, the first power supplier module 500, for driving a first load 504, comprises a first control circuit 508, a first converter 502 and a first detecting module 506. The first converter 502, for example: DC/DC converter or DC/AC converter, is coupled to an input power (not shown) and the first load 504, wherein the first load 504 is a set of LEDs or a Fluorescent lamp.

Additionally, the second power supplier module 540 for driving a second load 544, comprises a second control circuit 548, a second converter 542 coupled the input power and a second detection module 546, wherein the second detection module 546 is capable of detecting a current and/or a voltage passing the second load 544 and then outputting a second detection signal according to an operation status of the second load 544. The functions and operations of the second power supplier module 540 are similar to those of the first power supplier module 500. The detailed descriptions are not repeated. In this embodiment, the first detection module 506 functions to detect a current and/or a voltage passing through the first load 504 and then output a first detection signal according to an operation status of the first load 504. Moreover, the first control circuit 508 receives the first detection signal and outputs the first control signal to the first converter 502 to convert the input power to a first output power for driving the first load 504. Alternatively, the first control circuit 508 is adapted for adjusting the output voltage or current for driving the first load 504 if the first detection signal indicates the first load's driving voltage or current lower or higher than a default value. Meanwhile, the second control circuit 548 receives both the first and the second detection signals, and is adapted for outputting a second control signal to the second converter 542 to adjust a voltage or current for driving the second load 544 according to the calculation of the first and the second detection signals.

Referring to FIG. 5B, it shows a circuit block diagram representing another modified two-power-supplier duplexing operation apparatus according to a first embodiment of the present invention. Actually, the two-power-supplier duplexing operation apparatus is capable of executing duplexing operation or protection by adjusting power transmitted to the first load 504 (or the second load 544) is determined in accordance with a second detection signal (or a first detection signal) output from the second detection module 546 (or the first detection module 506). In this case, the first detection signal (or the second detection signal) is referred as a operation (or protection) detection signal, and the second control circuit 548 (or the first control circuit 508) to control the second converter 542 (or the first converter 502) to output the second output power (or the first output power) to the second load 544 (or the first load 504) according to the operation (or protection)(i.e.: the first detection signal). Therefore, the first and second control circuit 508 and 548 are capable of adjusting voltages or currents for driving the first and second loads 504 and 544 in accordance with the second detection signal and the first detection signal, respectively.

FIG. 5C shows a circuit block diagram representing three-power-supplier duplexing operation apparatus according to a first embodiment of the present invention. This embodiment is similar to the embodiment of FIG. 5A except for an additional third power supplier module 570 for driving a third load 574. The third power supplier module 570 comprises: a third control circuit 578, a third converter 572, and a third detection module 576. The operations and functions of the third power supplier module 570 are similar to the second power supplier module 540. Detailed descriptions are not repeated. Likewise, the embodiment of FIG. 5D is similar to the embodiment of FIG. 5B except for an additional third power supplier module 570 for driving a third load 574. Detailed descriptions are not repeated.

Now, please referring back to FIG. 1A, it shows a circuit block diagram of a two-lamp duplexing protection apparatus according to a narrow modification of the first embodiment of the present invention. In this modification, the two-lamp duplexing protection apparatus 10 comprises a first lamp module 100 and a second lamp module 140. Both of the lamp modules 100 and 140 are coupled to a power source. The first lamp module 100 and the second lamp module 140 output a first decision signal and a second decision signal, respectively.

According to this modification, the first lamp module 100 comprises a first converter 102, a first lamp 104, a first detecting-decision circuit 106 and a control circuit 108. The first converter 102 is coupled to the power source and the first lamp 104. The first converter 102 converts electrical power from the power source and supplies it to the first lamp 104. The first detecting-decision circuit 106 is coupled to the first lamp 104 and is adapted for outputting a first detecting signal and a decision signal. The first control circuit 108 is coupled to the first detecting-decision circuit 106 and is adapted for outputting a first control signal according to the first detecting signal and the second decision signal outputted from the second lamp module 140. The first converter 102 determines whether or not to output power according to the first control signal.

In this modification, the second lamp module 140 comprises a second converter 142, a second lamp 144, a second detecting-decision circuit 146 and a second control circuit 148. The functions and operations of the second lamp module 140 are similar to those of the first lamp module 100. The detailed descriptions are not repeated.

In this modification, the first detecting-decision circuit 106 comprises a first detecting circuit 110 and a first decision circuit 112. The first detecting circuit 110 is coupled to the first lamp 104 and is adapted for detecting the current flowing through the first lamp 104 to output a first detecting signal. The first decision circuit 112 is coupled to the first detecting circuit 110 and is adapted for controlling the current flowing through the first lamp 104 and output a first decision signal. The second detecting-decision circuit 146 comprises a second detecting circuit 150 and a second decision circuit 152. The operations and functions of the second detecting circuit 150 and the second decision circuit 152 are similar to those of the first detecting circuit 110 and the first decision circuit 112, respectively. Detailed descriptions are not repeated.

According to this modification, its feature resides on the first decision circuit 112 of the first lamp module 100 coupled to the second control circuit 148; and the second decision circuit 152 of the second lamp module 140 coupled to the first control circuit 108.

FIG. 1B is an operation flowchart of a two-lamp duplexing protection apparatus according to an embodiment of the present invention. Referring to FIGS. 1A and 1B, after the first lamp module 100 and the second lamp module 140 are enabled, the first converter 102 and the second converter 142 separately receive and convert power from the power source. After conversion, the power is outputted to the first lamp 104 and the second lamp 144.

After the first lamp 104 and the second lamp 144 are enabled, the first detecting circuit 110 and the second detecting circuit 150 detect currents flowing through the first lamp 104 and the second lamp 144 and output a first detecting signal and a second detecting signal, respectively (at step s102). The first decision circuit 112 and the second decision circuit 152 output a first decision signal and a second decision signal respectively according to the detection results above (at step s104).

In this modification, the first control circuit 108 receives the first detecting signal outputted from the first detecting circuit 110 and the second decision signal outputted from the second decision circuit 152. The second control circuit 148 receives the second detecting signal outputted from the second detecting circuit 150 and the first decision signal outputted from the first decision circuit 112. The first control circuit 108 calculates these signals and outputs a first control signal to the first converter 102 and determines whether or not to provide power to the first lamp 104 according to the first detecting signal and the second decision signal (at step s106). The second control circuit 148 calculates these signals and outputs a second control signal to the second converter 142 and determines whether or not to provide power to the second lamp 144 according to the second detecting signal and the first decision signal (at step s108).

After determining whether or not to provide power to the first lamp 104, the first converter 102 operates normally (at step s110). When it is determined not to provide power to the first lamp 104, the first converter 102 is turned off (at step s112). When it is determined to provide power to the second lamp 144, the second converter 142 operates normally (at step s114). When it is determined not to provide power to the second lamp 144, the second converter 142 is turned off (at step s116).

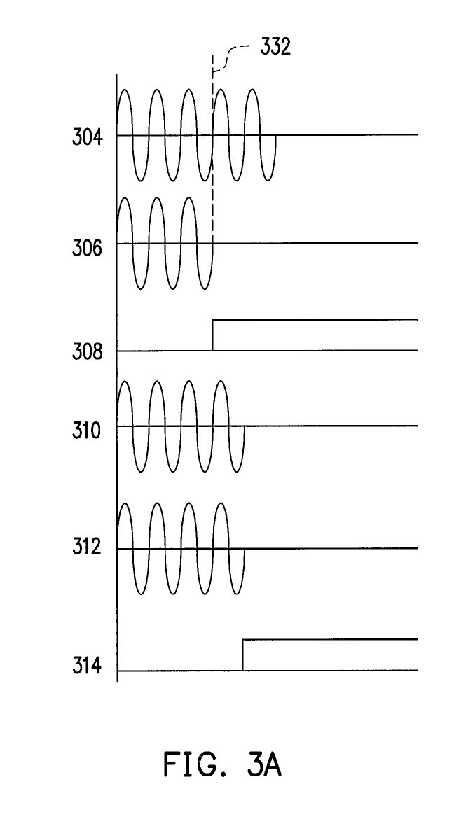

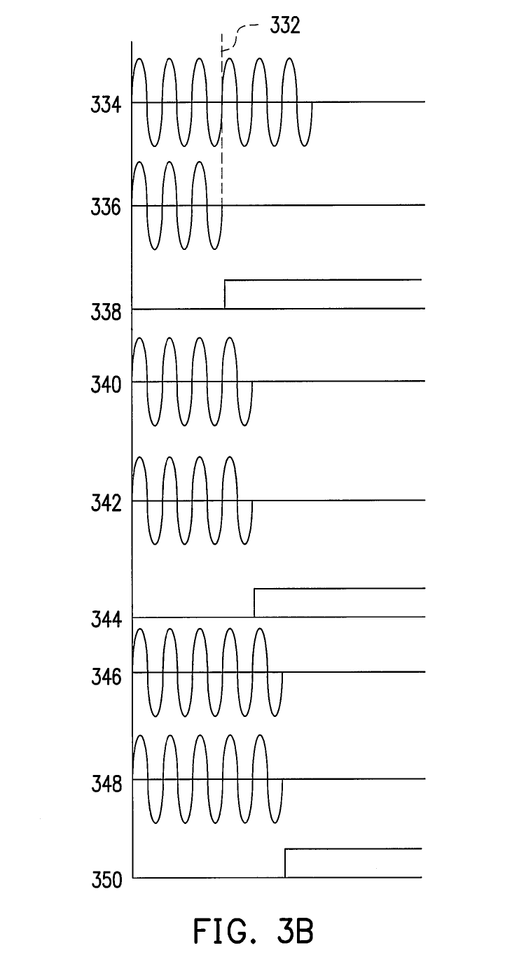

FIG. 3A is a time chart of a two-lamp duplexing protection apparatus according to a narrow modification of the first embodiment of the present invention. Referring to FIG. 3A, when first lamp 102 fails at the failure point 332, the first lamp 102 continues to output a voltage with waveform 304, but no current flows through the first lamp 102 (like waveform 306). A turn-off signal 308, such as a first decision signal, is triggered. The transmission of turn-off signal 308 is delayed for a short period of time and is adapted for turning off the control circuit 148 of the second lamp 144. next, a turn-off signal 314 is triggered. After a short time delay, the turn-off signal 314 is transmitted to turn off the first control circuit 108. The voltage signal with waveform 304 of the first lamp 104 is brought to zero. Thus, after the control circuit 148 is turned off, current and voltage (waveforms 312 and 310) supply to the first lamp is cut off.

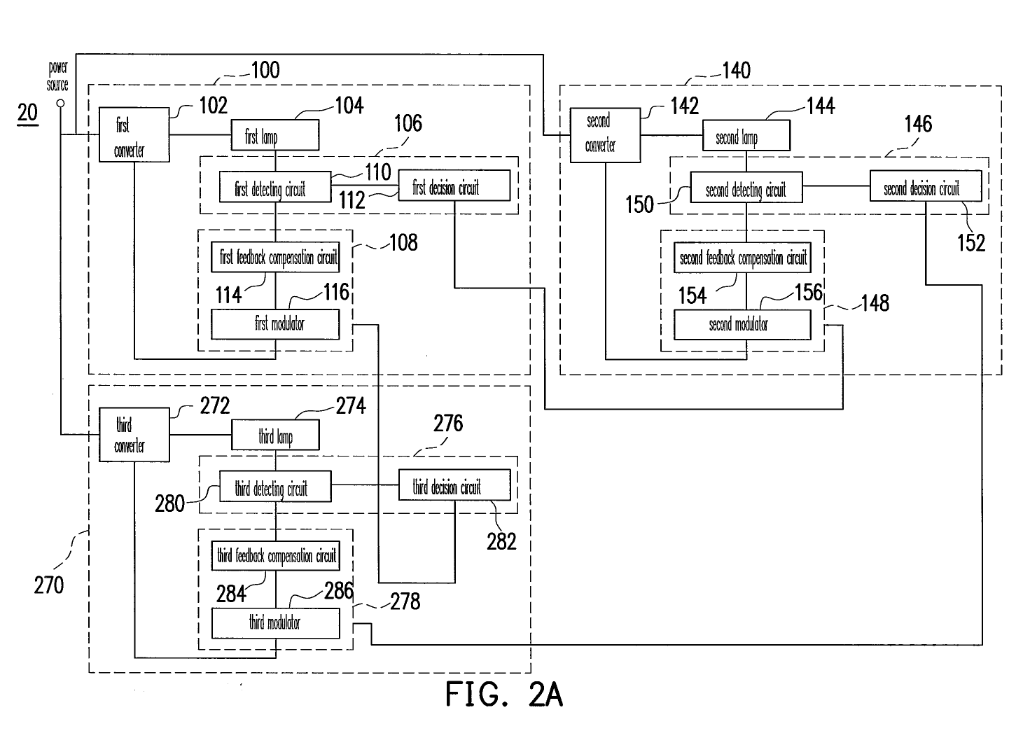

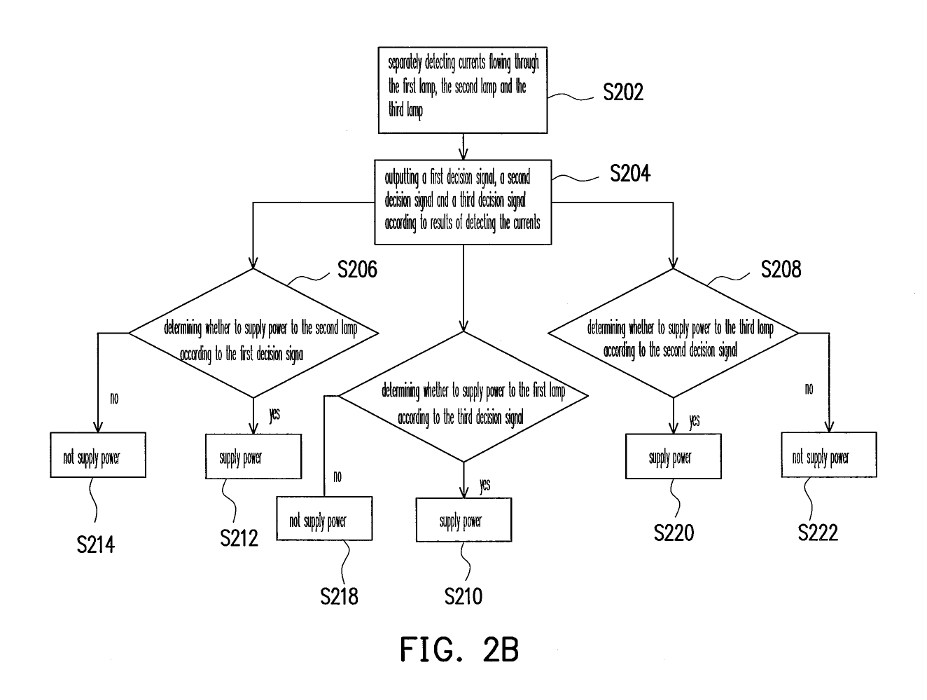

FIG. 2A is a circuit block diagram of a three-lamp duplexing protection apparatus according to a narrow modification of the first embodiment of the present invention. This modification is similar to the modification of FIG. 1A except for an additional third lamp module 270. The third lamp module 270 comprises: a third converter 272, a third lamp 174, a third detecting-decision circuit 276 and a third control circuit 278. The operations and functions of the third lamp module 270 are similar to those of the first lamp module 100 or the second lamp module 140. Detailed descriptions are not repeated.

Compared to the modification in FIG. 1A, the first decision circuit 112 is coupled to the second control circuit 148; the second decision circuit 152 is coupled to the third control circuit 278, and the third decision circuit 282 is coupled to the first control circuit 116.

FIG. 2B is an operational flowchart of a three-lamp duplexing protection apparatus according to a modification of the first embodiment of the present invention. Referring to FIGS. 2A and 2B, after the first lamp module 100, the second lamp module 140 and the third lamp module are enabled, the first converter 102, the second converter 142 and the third converter 272 separately receive and convert electrical power from the power source. After conversion, the power is outputted to the first lamp 104, the second lamp 144 and the third lamp 274.

After the first lamp 104, the second lamp 144 and the third lamp 274 are enabled, the first detecting circuit 110, the second detecting circuit 150 and the third detecting circuit 280 detect currents flowing through the first lamp 104, the second lamp 144 and the third lamp 274, and output a first detecting signal, a second detecting signal and a third detecting signal, respectively (at step s202). The first decision circuit 112, the second decision circuit 152 and the third decision circuit 282 output a first decision signal, a second decision signal and a third decision signal respectively according to the results of detecting the currents (at step s204).

In this modification, the first control circuit 108 receives the first detecting signal outputted from the first detecting circuit 110 and the third decision signal outputted from the third decision circuit 282. The second control circuit 148 receives the second detecting signal outputted from the second detecting circuit 150 and the first decision signal outputted from the first decision circuit 112. The third control circuit 278 receives the third detecting signal outputted from the third detecting circuit 280 and the second decision signal outputted from the second decision circuit 152. The first control circuit 108 calculates these signals and outputs a first control signal to the first converter 102 according to the first detecting signal and the third decision signal to determine whether or not to provide power to the first lamp 104 (at step s206). The second control circuit 148 calculates these signals and outputs a second control signal to the second converter 142 according to the second detecting signal and the first decision signal to determine whether or not to provide power to the second lamp 144 (at step s208). The third control circuit 278 calculates these signals and outputs a third control signal to the third converter 272 according to the third detecting signal and the second decision signal to determine whether or not to provide power to the third lamp 274 (at step s210).

After it is determined to provide power to the first lamp 104, the first converter 102 operates normally in step s212. When it is determined not to provide power to the first lamp 104, the first converter 102 is turned off (at step s214). After it is determined to provide power to the second lamp 144, the second converter 142 operates normally (at step s220). When it is determined not to provide power to the second lamp 144, the second converter 142 is turned off (at step s222). After it is determined to provide power to the third lamp 274, the third converter 272 operates normally (at step s216). When it is determined not to provide power to the third lamp 274, the third converter 272 is turned off (at step s218).

FIG. 3B is a time chart of a three-lamp duplexing protection apparatus according to a modification of the first embodiment of the present invention. Referring to FIG. 3B, when failing at the first lamp failure point 332, the first lamp 104 continues to output a voltage with waveform 334, but no current flows through the first lamp 104 (like waveform 336). A turn-off signal 338, such as a decision signal, is triggered. The turn-off signal 338 is delayed for a short time period and is adapted for turning off the control circuit 148 of the second lamp 144. After the control circuit 148 is turned off, no current and voltage (waveforms 312 and 310) is supplied to the first lamp 104. Next, a turn-off signal 334 is triggered. After a short time delay, the turn-off signal 334 is transmitted to turn off the third control circuit 278 of the third lamp 274. After the control circuit 278 is turned off, no current and voltage (waveforms 348 and 346) is supplied to the second lamp 144. Next, a turn-off signal 350 is triggered. After a short time delay, the turn-off signal is transmitted to turn off the first control circuit 108. The voltage signal with waveform 350 of the first lamp 104 is brought to zero.

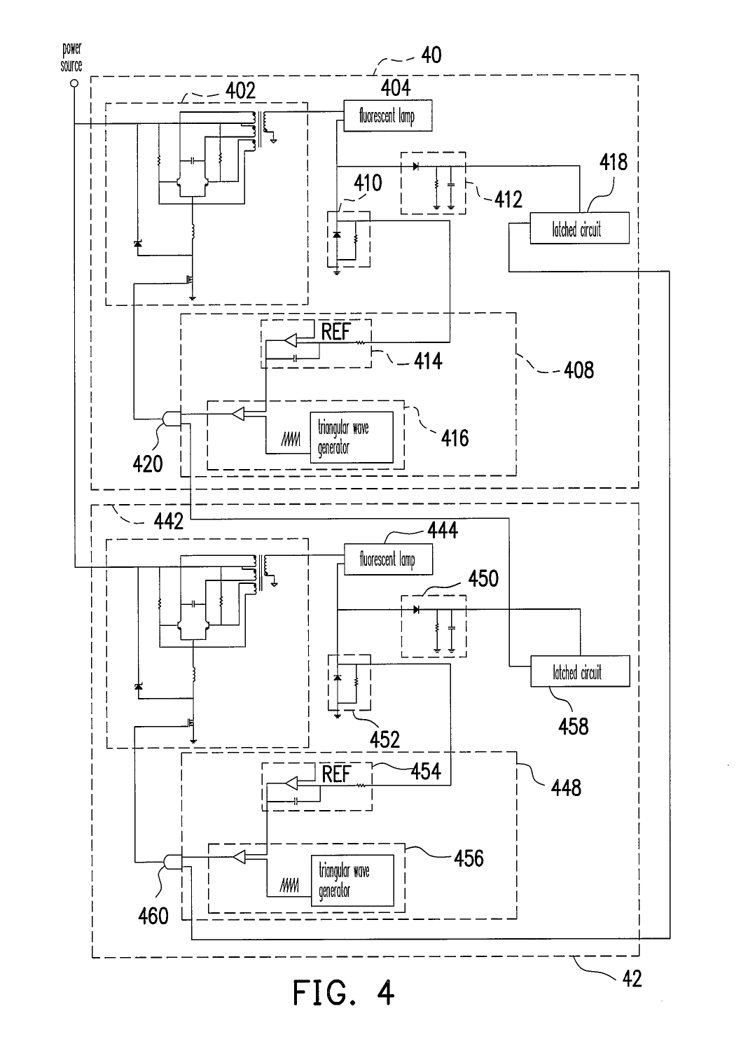

FIG. 4 is a detail circuit drawing of a two-lamp duplexing protection apparatus according to a modification of the first embodiment of the present invention. The circuit in FIG. 4 is an exemplary embodiment of the present invention. The scope of the present invention is not limited thereto. The two-lamp duplexing protection apparatus comprises lamp modules 40 and 42. The lamp module 40 comprises, for example, a converter 402, a fluorescent lamp 404, a detecting circuit 410, a decision circuit 412, a latched circuit 418, a control circuit 408, a feedback compensation circuit 414, a modulator 416 and an AND gate 420. The lamp module 42 comprises, for example, a converter 442, a fluorescent lamp 444, a detecting circuit 450, a decision circuit 452, a latched circuit 458, a control circuit 448, a feedback compensation circuit 454, a modulator 456 and an AND gate 460. The delay time can be, for example, 20 ms, but is not limited thereto.

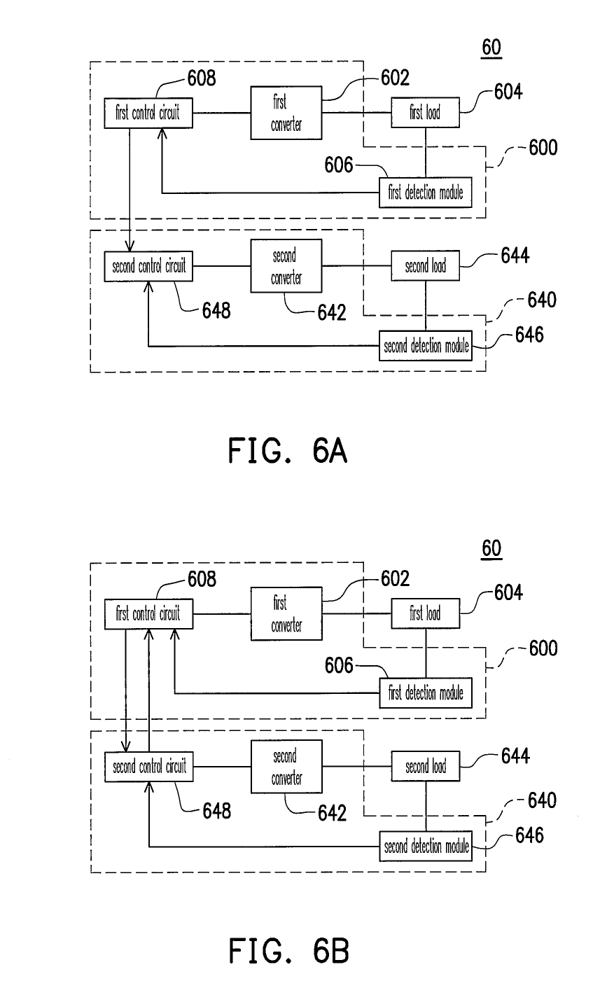

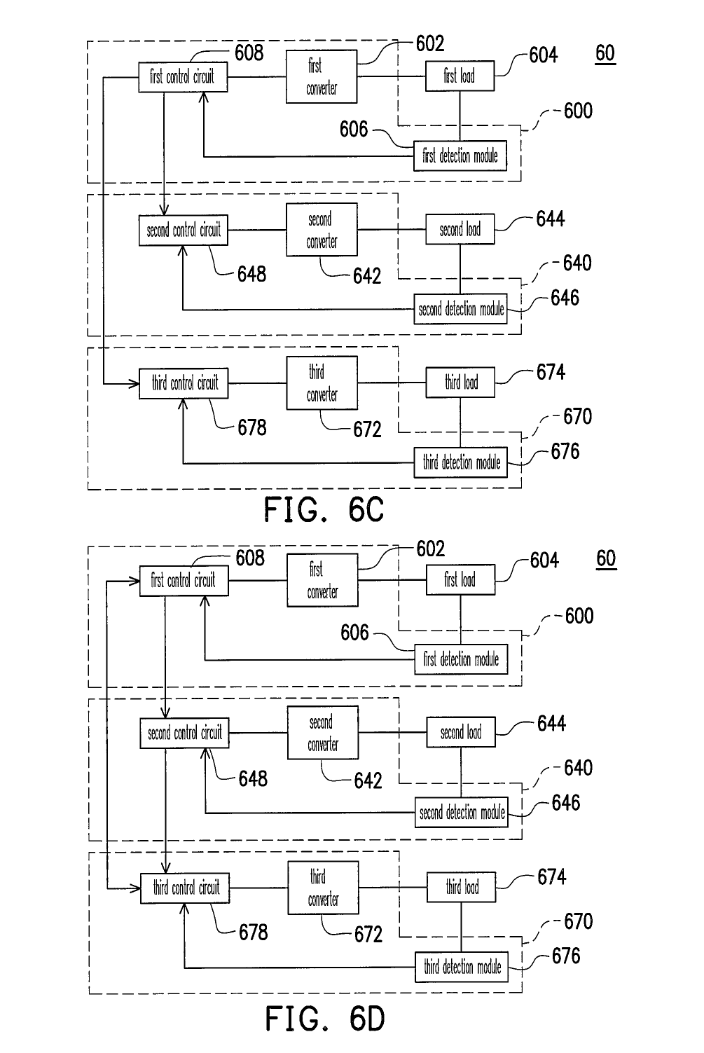

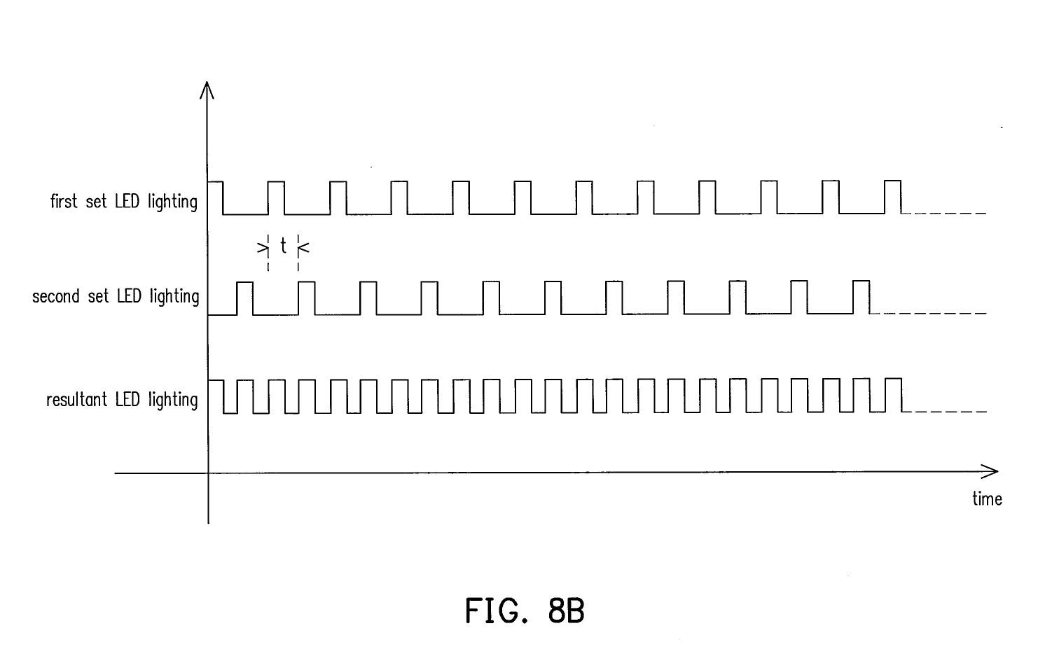

After the description of the first embodiment, a second embodiment and its specialized application are described as follows. Referring to FIG. 6A and FIG. 8A concurrently, a first control circuit 800, a first converter 810, a first load 820 and a first detection module 830 as shown in FIG. 8A, which constitute a first power supplier module 80 that are identical to reference numerals 608, 602, 604 and 606 as shown in FIG. 6A, respectively. Likewise, a second control circuit 800′, a second converter 810′, a second load 820′ and a second detection module 830′ as shown in FIG. 8A, which constitute a second power supplier module 80′ that are identical to reference numerals 648, 642, 644 and 646 as shown in FIG. 6A, respectively. From FIG. 6A, there shows a duplexing signal coming from the first control circuit 608, rather than from the first or the second detection module 506, 546 as shown in FIGS. 5A-5D, wherein the duplexing signal may be a frequency-synchronizing signal, a dimming signal or a soft-start signal. Furthermore, in this embodiment, the duplexing signal is referred as a command signal because it is a one-way communication signal. In FIG. 8A, each of the first control circuit 800 and the second control circuit 800′ comprise a frequency generator 801(801′), a PWM circuit 802 (802′), a protection circuit 803 (803′), a drive circuit 804 (804′) and a dimming circuit 805(805′), wherein the first power supplier module 80 is coupled to the second power supplier module 80′ through the coupling between the dimming circuit 805 and its counterpart 805′. The dimming circuit 805′ generates the dimming signal to the drive circuit 804′ according to the dimming signal generated by the dimming circuit 804. In such case, the dimming signals of the dimming circuits 804, 804′ have a time delay t there between, as shown in FIG. 8B. As a result, the resultant LED lighting frequency of the whole power supplier module (including the first and the second power supplier modules) is visually double the first set LED lighting (or the second set LED lighting), as shown in FIG. 8B, thereby achieving a functionality of reducing flicker caused by a dimming effect.

FIG. 6B shows a circuit block diagram represents another modified two-power-supplier duplexing operation apparatus according to a second embodiment of the present invention. FIG. 6A differs from FIG. 6B in that the latter is capable of two-way communication between two control circuits 608 and 648. FIG. 6C shows a circuit block diagram represents a three-power-supplier duplexing operation apparatus according to a second embodiment of the present invention. This embodiment is similar to the embodiment of FIG. 6A except for an additional third power supplier module 670 for driving a third load 674. The third power supplier module 670 comprises: a third control circuit 678, a third converter 672, and a third detection module 676. The operations and functions of the third power supplier module 670 are similar to the second power supplier module 640. Detailed descriptions are not repeated. Likewise, the embodiment of FIG. 6D is similar to the embodiment of FIG. 6B except for an additional third power supplier module 670 for driving a third load 674. Detailed descriptions are not repeated.

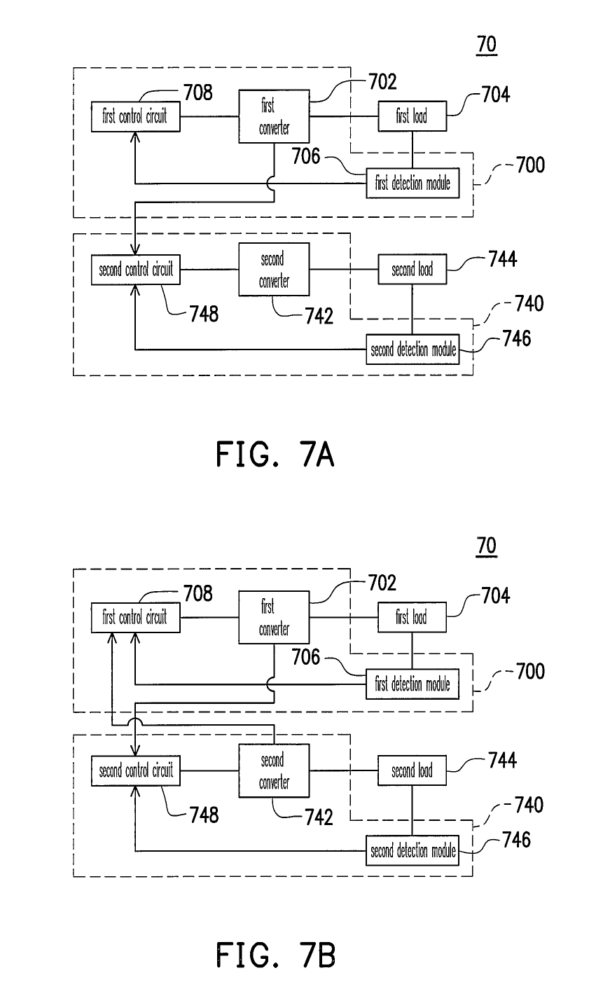

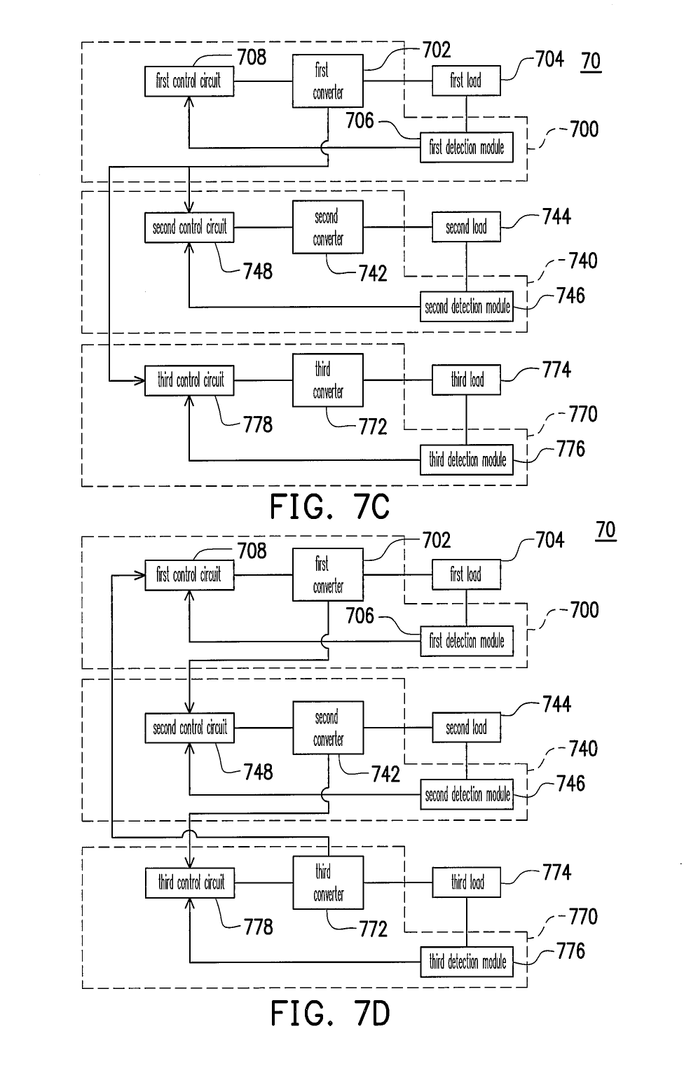

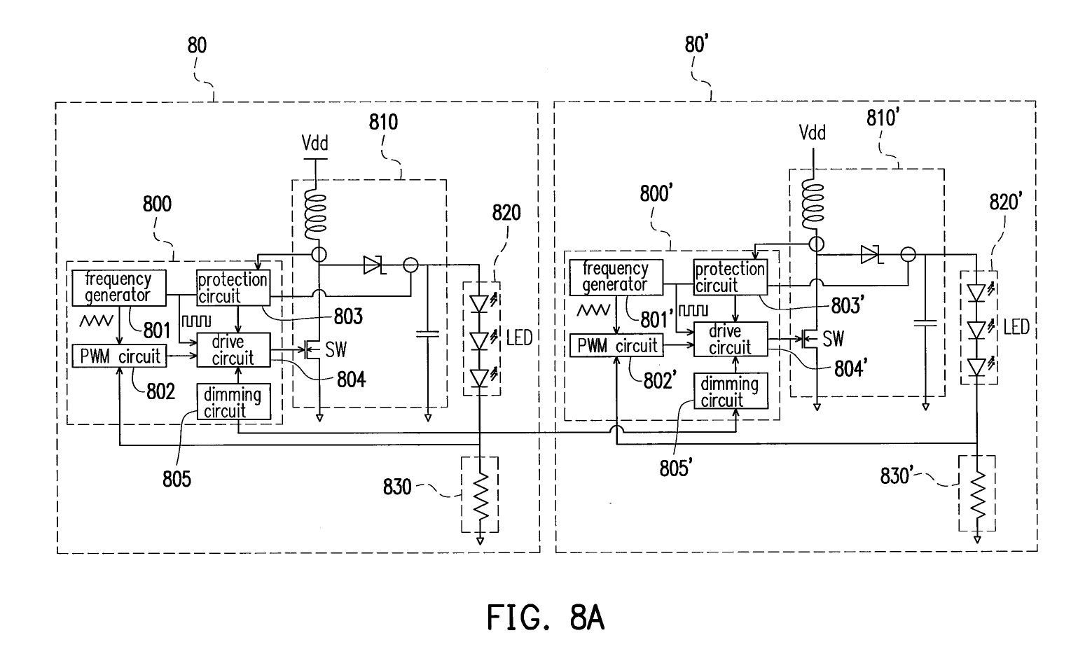

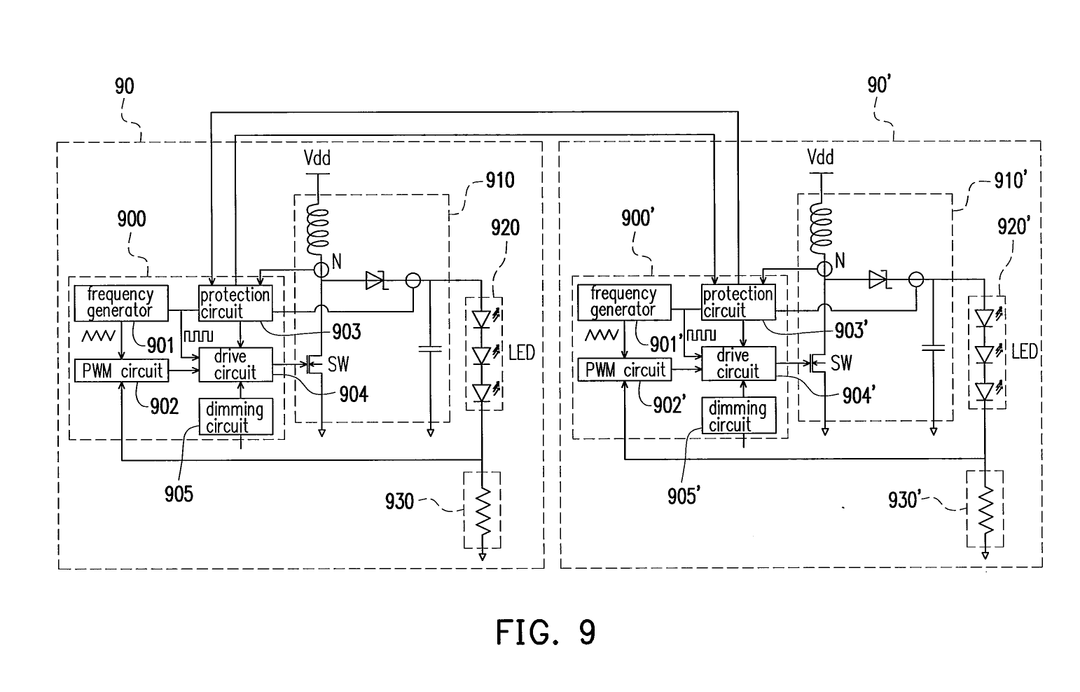

Referring to FIG. 7 A, it comprises the same elements as those of FIG. 6A, such as a first and second control circuits 708 and 748, a first and second converters 702 and 742, a first and second loads 704 and 744, and a first and a second detection module 706 and 746. However, FIG. 7 A shows the duplexing signal coming from the first converter 702, rather than from the first control circuit 608 as shown in FIG. 6A. Referring to FIG. 7B and FIG. 9 concurrently, FIG. 7B shows the first converter 702 and the second converter 742 that are able to issue the duplexing signals to their corresponding control circuits 748 and 708, thereby modulating the operation status (such as a malfunction) of one of the first power supplier module 700 and the second power supplier module 740 according to the operation status of the other. Moreover, the malfunction may be referred to abnormality of current or power. The circuit block diagram in FIG. 9 is the same as those in FIG. 8A. Hence, the descriptions for same elements are omitted. It is noted that a circle symbol N is designated to have a detector for detecting a power output from an inductor L. If a short circuit or a current leakage happens to one of a first converter 910 and a second converter 910′, which may be caused damage of the first converter 910 or the second converter 910′, the power provided by the first power supplier module 90 is dropped, for example, from 100 W to 50 W while the second power supplier module 90′ provides 100 W. As the first converter 910 and the second converter 910′ are duplexed through the coupling between the protection circuit 903 and its counterpart 903′, the first converter 910 issues a dupleximg signal to the second control circuit 900′ in order to lower the power provided by the second power supplier module 90′ from 100 W to 50 W. As a result, the first power supplier module 90 provides the same power as the second power supplier module 90′. On the other hand, if the abnormality of power-drop happens to the second power supplier module 90′, the second converter 910′ issues the dupleximg signal to the first control circuit 900 in order to lower the power provided by the first power supplier module 90 from 100 W to 50 W.

Embodiments shown in FIG. 7C and FIG. 7D are similar to those in FIG. 7A and FIG. 7B, respectively, except for an additional third power supplier module 770 for driving a third load 774.

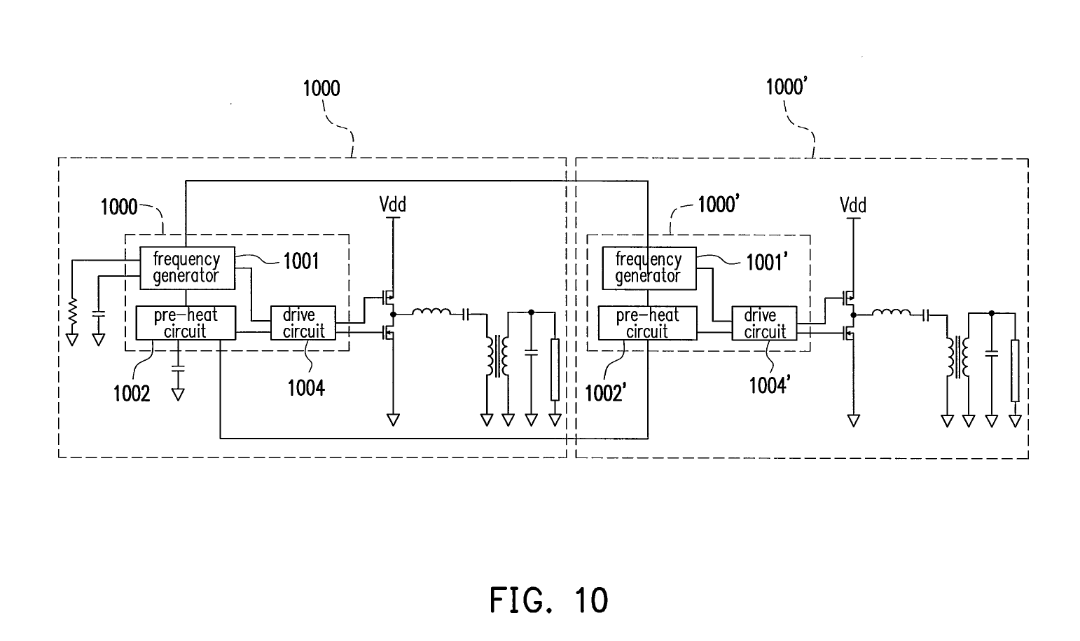

Referring to FIG. 10, it shows a block diagram of ballast according to a second embodiment of the present invention. The ballast comprises a first power supplier module 1000 and a second power supplier module 1000′, each of which includes a control circuit 1000 and 1000′. Each of the control circuits 1000 and 1000′ further comprises a frequency generator 1001(1001′), a drive circuit 1004 (1004′) and a pre-heat circuit 1002 (1002′). The frequency generator 1001(1001′) functions to convert a pre-heat frequency for heating a lamp (or LEDs) to a normal operation frequency once the lamp (or LEDs) is heated to be turned on by the pre-heat circuit 1002(1002′). In general ballast, an external resistor or/and capacitor is required for setting a pre-heat time and the pre-heat frequency; whereas, in FIG. 10, the external resistor or capacitor of the control circuits 1000′ can be eliminated because the pre-heat time and the pre-heat frequency are set by duplexing operation between the control circuits 1000 and 1000′ through the coupling of the frequency generators 1001 (1001′), thereby simplifying the structure of the ballast.

The present invention is also directed to a method of operating the power-supplier duplexing operation apparatus 50, 60 and 70. The method is implemented to control an operation of the power-supplier duplexing operation apparatus comprising a first power supplier 504, 604 and 704 and a second power supplier 440, 640 and 740 capable of respectively supplying power to loads 506,546, 606, 646, 706 and 746. The method comprises the steps of providing a first power-supplying signal which generated by the first power supplier for indicating a power-supplying status of the first power supplier 504, 604 and 704; and determining a power-supplying status of the second power supplier 540, 640 and 740 by the second power supplier according to the first power-supplying signal.

Alternatively, the power-supplier duplexing operation method comprises the steps of: providing a first duplexing signal which generated by the first power supplier; and controlling its power-supplying operation by the second power supplier according to the first duplexing signal. More, the first duplexing signal may be a frequency-synchronizing signal, a dimming signal or a soft-start signal. The second power supplier is capable of providing a second duplexing signal, and the first power supplier is able to control its power-supplying operation according to the second duplexing signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power-supplier duplexing operation apparatus, comprising:
a first power supplier for driving a first load, comprising a first control circuit, a first converter and a first detection module, wherein the first converter is coupled to an input power and converts the input power to a first output power for driving the first load in accordance with a control signal output from the first control circuit, as well as the first detection module outputs a first detection signal according to an operation status of the first load; and
a second power supplier for driving a second load, comprising a second converter, wherein the second converter is coupled to the input power and converts the input power to a second output power for driving the second load in accordance with the first detection signal.

2. The power-supplier duplexing operation apparatus of claim 1, wherein the second power supplier further comprises a second control circuit for controlling the second converter's converting the input power to the second output power for driving the second load in accordance with the first detection signal.

3. The power-supplier duplexing operation apparatus of claim 2, wherein the second power supplier further comprises a second detection module for outputting a second detection signal according to an operation status of the second load.

4. The power-supplier duplexing operation apparatus of claim 3, wherein the first control circuit is capable of controlling the first converter's converting the input power in accordance with the second detection signal.

5. The power-supplier duplexing operation apparatus of claim 3, wherein the second control circuit is capable of controlling the second converter's converting the input power in accordance with the second detection signal.

6. The power-supplier duplexing operation apparatus of claim 2, wherein the first load and the second load are selected one from a group comprised of a plurality of light-emitting diodes or a Fluorescent lamp.

7. The power-supplier duplexing operation apparatus of claim 2, wherein the first converter is a DC-to-DC converter or a DC-to-AC converter, and the second converter is a DC-to-DC converter or a DC-to-AC converter.

8. The power-supplier duplexing operation apparatus of claim 2, wherein the first detection signal is a current-detection signal or a voltage-detection signal.

9. The power-supplier duplexing operation apparatus of claim 2, wherein the first detection signal is a protection detection signal capable of enabling the second control circuit to control the second converter not to output the second output power to the second load when receiving the protection detection signal.

10. A power-supplier duplexing operation apparatus, comprising:
a first power supplier for driving a first load, comprising a first control circuit and a first converter, wherein the first converter is coupled to an input power and converts the input power to a first output power for driving the first load in accordance with a control signal output from the first control circuit, as well as the first control circuit outputs a first duplexing signal; and
a second power supplier for driving a second load, comprising a second control circuit and a second converter, wherein the second converter is coupled to the input power and converts the input power to a second output power for driving the second load in accordance with the first duplexing signal.

11. The power-supplier duplexing operation apparatus of claim 10, wherein the first power supplier further comprises a first detection module that outputs a first detection signal according to an operation status of the first load.

12. The power-supplier duplexing operation apparatus of claim 11, wherein the first control circuit outputs the first duplexing signal according to the first detection signal.

13. The power-supplier duplexing operation apparatus of claim 10, wherein the second power supplier further comprises a second detection module that outputs a second detection signal according to an operation status of the second load.

14. The power-supplier duplexing operation apparatus of claim 13, wherein the second control circuit outputs a second duplexing signal according to the second detection signal.

15. The power-supplier duplexing operation apparatus of claim 14, wherein the first control circuit is capable of controlling the first converter to convert the input power to the first output power in accordance with the second duplexing signal.

16. The power-supplier duplexing operation apparatus of claim 13, wherein the second control circuit further controls the second converter's converting the input power according to the second detection signal.

17. The power-supplier duplexing operation apparatus of claim 10, wherein the first duplexing signal is a frequency-synchronizing signal, a dimming signal or a soft-start signal.

18. The power-supplier duplexing operation apparatus of claim 10, wherein the first load and the second load are selected one from a group comprised of a plurality of light-emitting diodes or a Fluorescent lamp.

19. The power-supplier duplexing operation apparatus of claim 10, wherein the first converter is a DC-to-DC converter or a DC-to-AC converter, and the second converter is a DC-to-DC converter or a DC-to-AC converter.

20. A power-supplier duplexing operation method, for controlling an operation of a power-supplier duplexing operation apparatus comprising a first power supplier and a second power supplier capable of respectively supplying a power to loads, the method comprising:
providing a first power-supplying signal which generated by the first power supplier for indicating a power-supplying status of the first power supplier; and
determining a power-supplying status of the second power supplier by the second power supplier according to the first power-supplying signal.

21. The power-supplier duplexing operation method of claim 20, further comprising:
providing a second power-supplying signal which generated by the second power supplier for indicating a power-supplying status of the second power supplier.

22. The power-supplier duplexing operation method of claim 21, wherein the second power supplier further determines the power-supplying status of the second power supplier according to the second power-supplying signal.

23. The power-supplier duplexing operation method of claim 21, further comprising:
determining a power-supplying status of the first power supplier by the first power supplier according to the second power-supplying signal.

24. A power-supplier duplexing operation method, for controlling an operation of a power-supplier duplexing operation apparatus comprising a first power supplier and a second power supplier capable of respectively supplying a power to loads, the method comprising:
providing a first duplexing signal which generated by the first power supplier; and
controlling power-supplying operation of the second power supplier by the second power supplier according to the first duplexing signal.

25. The power-supplier duplexing operation method of claim 24, wherein the first duplexing signal is a frequency-synchronizing signal, a dimming signal or a soft-start signal.

26. The power-supplier duplexing operation method of claim 24, further comprising:
providing a second duplexing signal which generated by the second power supplier.

27. The power-supplier duplexing operation method of claim 26, further comprising:
controlling the first power supplier power-supplying operation by the first power supplier according to the second duplexing signal.
